(19) United States
(12) Patent Application Publication
(10) Pub. No.: US 2010/0040860 A1
(43) Pub. Date: Feb. 18, 2010

(54) ALL-COMPOSITE SHEET GLASS PANEL FOR RECREATIONAL VEHICLE EXTERIOR WALL

(76) Inventors: Wenguang Ma, Elkhart, IN (US); Todd B. Irick, Middlebury, IN (US); Robert A. Barney, Elwood, IL (US)

Correspondence Address: FITZPATRICK CELLA HARPER & SCINTO, 1290 Avenue of the Americas, NEW YORK, NY, 10104-3800, US

(21) Appl. No.: 12/344,999

(22) Filed: Dec. 29, 2008

Related U.S. Application Data
(63) Continuation-in-part of application No. 12/192,734, filed on Aug. 15, 2008, now abandoned.

(51) Int. Cl. B32B 5/18; B32B 37/02

(52) U.S. Cl. 428/304.4; 156/278; 156/280; 156/279

(57) ABSTRACT

A method of manufacturing a composite sheet includes using a porous reinforcement panel of thermoplastic. A mold surface onto which the composite sheet will be formed is provided. At least one outer coat of material is applied onto the mold surface. At least one coat of resin and reinforcement material is applied over the outer coat to form a reinforcement layer. A porous thermoplastic reinforcement panel is applied to the reinforcement layer, and is bonded to the reinforcement layer. An additional coat of resin may optionally be applied onto the reinforcement panel. If the optional coat is applied onto the reinforcement panel, the reinforcement material may or may not be used with resin. Vacuum force or compression force may be applied to the laminate to assist the resin curing and the bonding, or curing may be performed without the application of pressure.

### TECHNICAL FIELD

This is a continuation-in-part of Ser. No. 12/192,734, filed Aug. 15, 2008, the entire content of which is incorporated herein by reference. This invention relates in general to a method and apparatus for the manufacture of fiber-reinforced panels, and in particular, to a method and apparatus for the manufacture of a composite sheet suitable for such uses as a recreational vehicle wall.

### BACKGROUND OF THE INVENTION

### Field of the Invention

It is commonplace in the manufacture of recreational vehicles to use composite sheets, such as glass fiber-reinforced wall panels, for the exterior surface of the recreational vehicle. These wall panels vary in dimensions up to, and including, from 2.4 to 3 meters (8 to 10 feet) wide, and can have a length as great as 15 meters (50 ft.) or more.

For a number of years, various manufacturers have produced sheet glass panels for RV exterior walls, in which the panels contain a layer of lauan plywood. These panels have the structure of (i) a gel coat with (ii) chopped glass and resin composite reinforcement with (iii) a lauan plywood substrate, and are made by an open-mold-spraying and vacuum-bagging process (i.e., applying a vacuum using a bag for pressure containment). The low-viscosity liquid unsaturated polyester resin that is mixed with the chopped glass to provide the reinforcement can fill the gaps between the edges of the lauan panels, and partially penetrate the plywood.

The process of making such a composite material begins with an elongate mold. The mold is somewhat larger than the panels to be made, but large enough to accommodate the 3×15 meter (10×50 ft.) panels. The upper surface of the mold is a finished surface to provide a substantially flat and smooth surface, as it is this surface which forms the exterior surface of the panels to be made.

The mold is first sprayed with a coating known as a gel coating, which cures to form a high gloss exterior surface for the panel. Once cured, a resin and fiberglass are placed on the back (exposed) side of the gel coating, and then a plurality of panels of lauan are positioned side by side on top of the fiberglass. A vacuum bag is then placed over the top of the panels and a slight vacuum is introduced, which draws resin into the lauan panels to form a finished product. The completed product is then pulled off of the mold and cut and trimmed to the proper size.

In addition to such composite panels, Crane Composites also produces a type of all-composite exterior wall panel (sold under the trademark CTEC) for use in recreational vehicles. This material has uniform and consistent properties, does not crack, does not absorb water and will not rot. However, the raw-material costs are high, and the manufacture of this product requires considerable investment, and requires a longer molding cycle time than is encountered in manufacturing panels reinforced with lauan.

Despite the relatively low cost of lauan plywood, the present inventors note various disadvantages in using that material. Aside from requiring the cutting of trees to make the lauan, that material is not entirely uniform or consistent in its properties from panel to panel. In addition, lauan can emit certain amounts of formaldehyde, and has a strong propensity to absorb and retain water, and thus is susceptible to rotting. In addition, the lines between adjoining panels of lauan may be visible in the finished product, which is unesthetic, and voids in the lauan may turn into cracks and spread (commonly referred to as “telegraphing”), applying a high stress to the composite layer, with the potential to cause micro-cracking of the gel coat surface upon exposure to hot, cold and damp weather conditions.

### SUMMARY OF THE INVENTION

The object of providing an advance over existing composite materials that incorporate lauan, as well as other objects not specifically enumerated, is achieved by a method and apparatus for manufacturing a composite sheet according to the present invention. The method of manufacturing a composite sheet includes using a porous reinforcement panel made of a thermoplastic material. A mold surface onto which the composite sheet may be formed is provided. At least one outer coat of material is applied onto the mold surface. At least one coat of resin and reinforcement material, preferably although not necessarily glass fibers, is applied over the outer coat to form a reinforcement layer. The porous thermoplastic reinforcement panel or substrate is applied to the reinforcement layer when the reinforcement layer is still wet. The resin of the reinforcement layer works as a glue to bond the reinforcement layer to the reinforcement panel through application of a vacuum. A coat of wet resin with or without a layer of glass mat can be applied on the top surface of the reinforcement panel before application of a vacuum.

In another embodiment of the invention, a mold surface onto which the composite sheet may be formed is provided. One or more dispensing mechanisms (which may themselves be conventional equipment) dispense at least one outer coat of material onto the mold surface, and at least one coat of resin over the outer coat. At least one applicator mechanism is provided to apply reinforcement material (again, preferably glass fibers) over the outer coat, where the resin and the reinforcement material together form a reinforcement layer. A vacuum mechanism is used to bond a porous thermoplastic reinforcement panel to the reinforcement layer, via the resin from the reinforcement as glue. A layer of wet resin with or without a layer of glass mat can be applied on the top surface of the reinforcement panel before application of a vacuum.

In another embodiment of the invention, a composite sheet includes a layer of outer coat material. A layer of resin and reinforcement material is applied to the outer coat layer, the layer of resin and reinforcement material forming a reinforcement layer. A porous reinforcement panel of thermoplastic material is applied to the reinforcement layer, and the liquid resin from the reinforcement layer secures the reinforcement layer to the reinforcement panel. A layer of wet resin with or without a layer of glass mat can be applied on the top surface of the reinforcement panel before application of a vacuum.

Various additional objects, features and advantages of this invention will become apparent to those skilled in the art from the following detailed description of the preferred embodiments, when read in light of the accompanying drawings.

### BRIEF DESCRIPTION OF THE DRAWINGS

FIG. 1 is a schematic view in elevation, partially in cross-section, of an the manufacture of a composite sheet according to the invention, illustrating the application of several layers of the composite sheet.

FIG. 2 is an enlarged cross-sectional view in elevation of a portion of the apparatus shown in FIG. 1, illustrating the use of a vacuum bag attached to the mold.

### DETAILED DESCRIPTION OF THE PREFERRED EMBODIMENTS

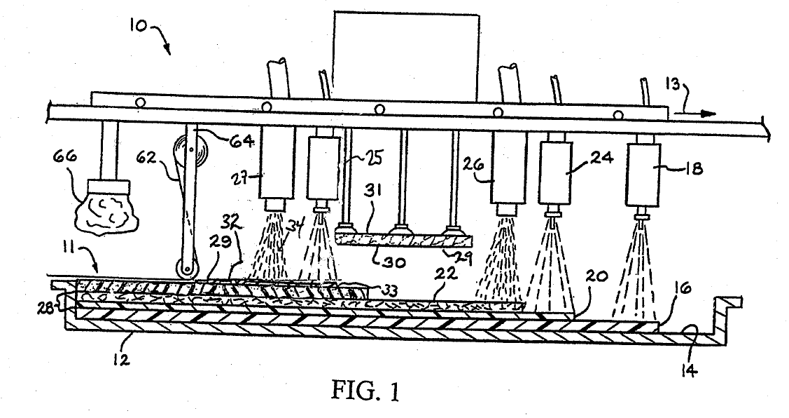

Referring now to the drawings, there is shown in FIG. 1 an apparatus 10 for manufacturing a composite sheet 11 according to the invention. The illustrated manufacturing process involves passing a series of manufacturing operations over an elongate mold 12 in a direction indicated by the arrow 13 in FIG. 1. The mold 12 is made of any suitable material, such as fiberglass composite. Typically the mold 12 is somewhat larger than the composite sheet to be made, and large enough to accommodate a 3×15 meter (10×50 ft.) composite sheet. An upwardly facing surface 14 of the mold 12 has a smooth face to provide a substantially flat and smooth surface to the composite sheet 11. The surface 14 forms the exterior surface of the composite sheet to be made.

In a first step of the manufacturing process, an outer coat of material is applied to the surface 14 of the mold 12. Typically, the outer coat is a gel coat 16, but may be any suitable material such as a veneer or a composite material. The gel coat 16 is a commercially available quick setting polymer applied to the surface of the mold. The gel coat 16 cures to form a high gloss exterior surface for the finished composite sheet 11. The gel coat 16 may include a pigment and provides a durable and esthetically pleasing outer surface for the finished composite sheet 11. Preferably, the gel coat 16 is applied in two layers by a sprayer 18 (although it is within the invention to apply a different number of layers thereof). Typically, the sprayer 18 is moved longitudinally along rails and sprays the entire length of the elongate mold 12. The sprayer 18 may be a conventional sprayer, such as one that is commercially available from Magnum Venus of Kent, Wash. The spray head of the sprayer 18 preferably traverses across the width of the mold 12 and discharges the gel coat 16 in a spray pattern and with a substantially uniform thickness. Preferably, the gel coat 16 is a polymer having a catalyst which sets to a gel in about 20 minutes and cures, or hardens, in about 35 minutes.

It will be understood that more than one sprayer 18 may be used to apply the gel coat 16, and that other methods for applying the gel coat 16 can be used.

In a second step of the manufacturing process, a composite mixture of resin 20 and reinforcement material, such as chopped fiberglass 22, is applied to the gel coat 16 to form a reinforcement layer 28. The resin 20 may comprise a polymer similar to the gel coat 16, but without a pigment. The resin 20 may be any suitable commercially available polyester resin, such as CoREZYN COR61-AA-830 DCPD laminating resin, from Interplastic Corporation, Minneapolis, Minn. Preferably, however, a polyester/epoxy blend resin having a low shrink characteristic, such as AME 2000 LB 6527-017, from the Ashland Specialty Chemical Company, Composite Polymers Division, Bartow, Fla., will be used.

Preferably, the resin 20 is applied by a resin sprayer 24, and the fiberglass 22 is applied by a fiberglass applicator 26. The resin sprayer 24 and the fiberglass applicator 26 can both be conventional. The fiberglass applicator 26 is designed for chopping fiberglass into fibers 22 of a desired length and dispensing the chopped fibers 22 in various sizes to form a laminate or reinforcement layer 28 consisting of a mixture of the resin 20 and the fiberglass fibers 22. Such dispensing and spray apparatus may be obtained commercially, for example from Magnum Venus.

Like the sprayer 18, the sprayer 24 and applicator 26 preferably move longitudinally along rails, and traverse across the mold 12, and discharge resin 20 and chopped fiberglass 22, respectively, in a pattern and with a substantially uniform thickness. In another embodiment, the mold 12 can move longitudinally along rails, and the sprayer 18, the sprayer 24 and applicator 26 stay in the designated position, and just traverse across the mold 12. It will be understood that more than one resin sprayer 24 and fiberglass applicator 26 may be used to apply the resin 20 and the fiberglass fibers 22.

When applying the resin 20 and the chopped fiberglass 22, either the resin 20 or the fiberglass 22 can be applied first, or the resin 20 and the fiberglass 22 can be applied simultaneously. The reinforcement layer 28 may be rolled with weighted rollers (not shown) to remove air from the reinforcement layer 28.

In an alternative embodiment of the invention (not shown), the chopped fiberglass fibers are replaced by a glass mat or other suitable reinforcement material. The mat is applied to the resin in a manner similar to the chopped fiberglass fibers described above, that is, so as to produce a substantially uniform reinforcement layer. In a further such alternative embodiment, such a glass mat is saturated with the polymer resin 20 and applied on top of the gel coat material 16, thereby eliminating the steps of applying the chopped fiberglass 22 and spraying the resin 20. Furthermore, the mat may comprise non-woven mat, or a stitched or knitted mat so as to provide strength characteristics as desired.

In a third step of the manufacturing process, a plurality of porous thermoplastic reinforcement panels 29 are applied to the reinforcement layer 28 in a side-by-side manner to cover the reinforcement layer 28 when the resin 20 is still wet, so the resin works with fiberglass forming the reinforcement layer and as glue bonding the reinforcement panels 29 with the reinforcement layer 28. The reinforcement panels 29 are preferably panels made of porous fiberglass thermoplastic composite, and are commercially available from Azdel under its SuperLite VGX trademark, from Owens-Corning under its AcoustiMax trademark and from Quadrant Plastic Composites, Inc. under its SymaLITE trademark (the panels can instead be made of a porous fiberglass thermosetting plastic composite). Each panel 29 typically has a thickness of about 1 to 5 mm. The surfaces 30 and 31 may be smooth, but need not be. The panels 29 are abutted together along their respective edges, and typically have a length equal to the width of the composite panel 11 that is being manufactured. Thus, for example, the reinforcement panels may be 1.2×2.4 meter (4 ft.×8 ft.) panels, and the 2.4 m (8 ft.) length of the panel 29 corresponds to the width of the composite sheet 11.

As shown in FIG. 1, the panels 29 can be lowered onto the reinforcement layer by mechanical means, but it is also within the broad scope of the invention for them to be put in place manually.

If desired, strips of webbing 32, such as strips of fiberglass mat, are wetted with a catalyzed resin and applied at each seam between adjacent reinforcement panels 29 to reinforce the composite sheet 11.

Although the composite sheet 11 is described as having a plurality of reinforcement panels 29, it will be understood that a continuous reinforcement backing may be provided instead, thereby eliminating the seams between panels and eliminating the webbing 32. If this embodiment is adopted, then the continuous reinforcement backing that is used instead of discrete panels 29 may be applied to the reinforcement layer 28 by being taken straight from a roll, or applied in any other manner that is convenient.

Furthermore, the panels 29 may comprise substantially thicker panels, depending on the application; for example 19 mm (¾ inch) thick sheets may be used if the product is intended for incorporation in a truck body.

In a fourth step, one layer of resin 33 is sprayed on the exposed surface 31 of the panels 29 by an additional sprayer 25, which is the same as sprayer 18. The resin 33 also can be used with a layer of glass 34 for increasing the bending stiffness of the composite sheet 11. The glass 34 will be chopped glass sprayed by an applicator 27, which is like applicator 26. Alternatively, the glass 34 can be a continuous glass mat, such as a fiberglass veil mat, chopped fiberglass strand mat or fiberglass woven roving, applied by a roll. If desired, this fourth step can be eliminated, or just the additional layer of resin 33 may be applied, without glass.

It is possible that pockets of air may become trapped between the reinforcement panel 29 and the gel coat layer 16 of the composite sheet 11. More particularly, air may become trapped between the reinforcement panel 29 and the reinforcement layer 28. Such trapped air can cause a distorted appearance on the finished surface 16 of the composite sheet 11, and this results in composite sheets 11 that must be scrapped or remanufactured, adding cost and time to the manufacturing process. The distorted appearance may worsen over time due to the effects of heat related expansion and contraction of both the trapped air and the composite sheet 11.

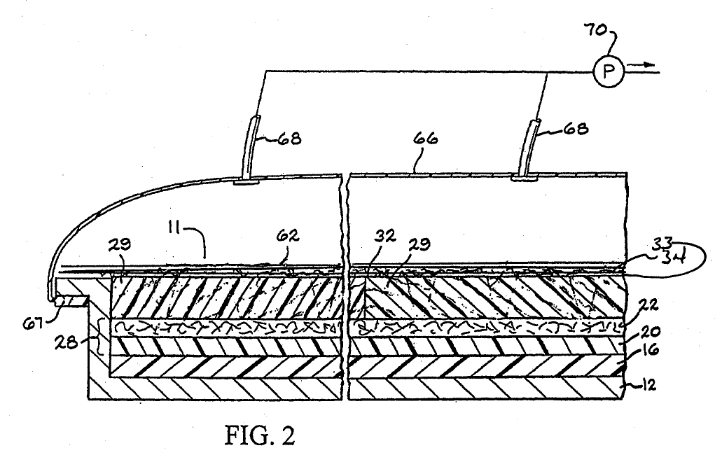

In a fifth step of the manufacturing process, therefore, means for applying a vacuum, such as the vacuum bag 66, is placed around the mold 12, as illustrated in FIG. 2. The vacuum bag 66 may be secured to the mold 12 by any suitable means, such as an elastomeric band 67 or clamps (not shown). The vacuum bag 66 includes a plurality of vacuum lines 68. The vacuum lines 68 are connected to a vacuum pump 70. The vacuum pump 70 creates a vacuum pressure, preferably within the range of from about 5.0 cm (2.0 in.) Hg to about 77.8 cm (30.0 in.) Hg. More preferably, the vacuum pump 70 creates a vacuum pressure of about 13 to 39 cm (5 to 15 in.) Hg. One piece of plastic breath sheet 62 is used for covering the entire mold 14 (and thus the entire composite panel 11). The breath sheet may be of the material sold under the trademark Mylar (which is a trademark of E.I. DuPont de Nemours & Co.), although other materials can be used in addition, as is known to those in the art. The vacuum pump pulls the air from between the bag 66 and the top composite layer 33/34. The vacuum draws the layers of the composite sheet 11 together, and pulls out any air trapped anywhere between the top composite layer 33/34 and the gel coat 16.

After the reinforcement layer 28 and the top composite layer 33/34 harden, the vacuum bag 66 is removed from the mold 12. When the composite sheet 11 is fully cured, the sheet 11 is removed from the mold 12. The sheet 11 may be removed from the mold 12 by a lifting mechanism (not shown) and moved to a location for additional processing, such as trimming and inspection.

Alternatively, a press platen may be used to apply pressure to the composite sheet 11 to aid in eliminating air bubbles. It is also within the scope of the invention, however, to allow free curing of the resin without the application of pressure.

The principle and mode of operation of this invention have been described with reference to the preferred embodiments. However, it should be noted that this invention may be practiced otherwise than as specifically illustrated and described without departing from its scope. For example, the mold 12 may be movable relative to a plurality of stationary manufacturing operations, such as the gel coat sprayer 16, the resin sprayer 24 and 25, and the fiberglass applicator 26 and 27, as described in commonly-assigned U.S. Pat. No. 6,854,499, or may be used in a continuous molding process as described in commonly-assigned U.S. Pat. No. 6,755,633, both of which are incorporated herein by reference.

The inventors have found that this invention provides an all-composite sheet suitable for use as an RV exterior wall panel, and does so using a well-understood high-productivity mold process. In addition, a sheet made according to the present invention has advantages over conventional lauan-backed panels, being lighter in weight, more consistent in quality and properties of the material, better moisture resistance, greater durability, thermal stability and thermal insulation, as well as better surface appearance, with very minor border lines. In addition, a sheet according to the present invention has no formaldehyde emission.

Many additional variations and modifications of the foregoing embodiments will now be apparent to those skilled in the art, and thus, the scope of this invention is not to be limited by the details of the foregoing embodiments, but rather is set out by the scope of the following claims.

What is claimed is:

1. A method of manufacturing a composite sheet comprising the steps of:
providing a mold surface on which a composite sheet may be formed;
applying at least one outer coat of material onto the mold surface;
applying at least one coat of resin and reinforcement material over the outer coat to form a reinforcement layer;
applying a porous reinforcement panel to the reinforcement layer, the porous reinforcement panel comprising a thermoplastic material;
bonding the reinforcement layer to the porous reinforcement panel; and
optionally applying at least one coat of resin with or without reinforcement material over the porous reinforcement panel.

2. The method of manufacturing a composite sheet according to claim 1, wherein the porous reinforcement panel comprises at least one thermoplastic material and at least one reinforcement material.

3. The method of manufacturing a composite sheet according to claim 1, wherein the thermoplastic material is a polyolefin, polyethylene, polypropylene or polyethylene terephthalate, and wherein the reinforcement material is natural fibers, glass fibers and/or synthetic fibers.

4. The method of manufacturing a composite sheet according to claim 2, wherein the porous reinforcement panel comprises polypropylene as the thermoplastic material and glass fiber as the reinforcement material, in a ratio of 10/90 to 90/10 (glass/thermoplastic), inclusive.

5. The method of manufacturing a composite sheet according to claim 2, wherein the ratio is in a range of from 45/55 to 55/45, inclusive.

6. The method of manufacturing a composite sheet according to claim 2, wherein the panel has a thickness of from 1 to 5 mm, inclusive.

7. The method of manufacturing a composite sheet according to claim 6, wherein the panel thickness is from 2 to 4 mm, inclusive.

8. The method of manufacturing a composite sheet according to claim 1, wherein the bonding step comprises applying a vacuum to the laminate.

9. The method of manufacturing a composite sheet according to claim 1, wherein the bonding step comprises applying a press platen to the laminate.

10. The method of manufacturing a composite sheet according to claim 1, wherein the bonding step comprises free curing without any force being applied to the laminate.

11. The method of manufacturing a composite sheet according to claim 1, wherein the resin of the reinforcement layer also works as a glue bonding the porous reinforcement panel and the reinforcement layer together.

12. A composite sheet, comprising:
at least one outer coat of material;
at least one coat of resin and reinforcement material applied over the outer coat to form a reinforcement layer;
a porous reinforcement panel bonded to the reinforcement layer, the porous reinforcement panel comprising a thermoplastic material and fiber reinforcement material; and
optionally, one coat of resin with or without reinforcement material applied over the porous reinforcement panel.
